(19) United States
(12) Patent Application Publication
(10) Pub. No.: US 2026/0350120 A1
(43) Pub. Date: Nov. 5, 2026

(54) FUNCTION DISCOVERY FOR STRIPPED BINARY ANALYSIS

(71) Applicant: Intel Products IP LLC, Santa Clara, CA (US)

(72) Inventors: Qing WANG, Shanghai (CN); Wei XIAO, Shanghai (CN); Lingling KONG, Shanghai (CN)

(21) Appl. No.: 19/713,809

(22) Filed: Jun. 19, 2026

(30) Foreign Application Priority Data
Mar. 20, 2026 (WO) PCT/CN2026/084808

(51) Int. Cl. G06F 21/14; G06F 9/448

(52) U.S. Cl. CPC G06F 21/14; G06F 9/4486

(57) ABSTRACT

Function boundary discovery for a stripped binary executable includes obtaining execution profiling data indicative of executed addresses and branch targets, populating a credible address data structure with addresses derived from the execution profiling data, and discovering rough function boundaries by decoding instructions in the credible address data structure and identifying function entry points from call targets encountered during the decoding. A control flow graph is constructed for a rough function boundary, and an upper bound of the rough function boundary is determined based on a last instruction reachable within the control flow graph. When a jump instruction within a first function boundary has a target address outside the first function boundary, and a jump instruction within a second function boundary also targets the target address, the target address is identified as a new function entry point and the first function boundary is split into refined function boundaries.

### CROSS-REFERENCE TO RELATED APPLICATIONS

This application claims the benefit of International Application No. PCT/CN2026/084808, filed Mar. 20, 2026, the contents of which are incorporated herein by reference in their entirety.

### BACKGROUND

Binary analysis tools may operate on production executables from which symbol tables and debugging metadata have been removed, commonly referred to as stripped binaries. Function boundary discovery in such binaries is a prerequisite for a range of downstream tasks, including binary translation, performance optimization, security analysis, and reverse engineering. When symbol information is present, function boundaries can be determined directly from the metadata. In stripped binaries, however, this information is unavailable, and analysis tools must instead infer function boundaries from the machine code itself. This inference is complicated by several factors. Modern compilers apply optimizations that disrupt the contiguous layout traditionally associated with functions. Tail-call optimization replaces a call-and-return sequence with a direct jump, eliminating the return instruction that would otherwise demarcate a function exit. Function splitting separates infrequently executed (cold) code from frequently executed (hot) code, placing them in different regions of the executable section. Jump table generation introduces data embedded within executable sections, creating regions that, if decoded as instructions, produce erroneous results.

Indirect control flow presents an additional challenge. Function pointers, virtual method dispatch, and computed branch targets create execution paths that cannot be fully resolved by examining the binary alone. Functions that are reached exclusively through indirect calls may accordingly not be associated with any directly observable call target in the machine code.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the proposed configuration. In the following description, various aspects are described with reference to the following drawings, in which:

FIG. 1 shows an example flowchart of a multi-phase function boundary discovery method for a stripped binary executable, in various aspects;

FIG. 2 shows an example diagram illustrating discovery of function boundaries by constructing a control flow graph for a function and identifying an upper bound based on the last reachable instruction, in various aspects;

FIG. 3 shows an example diagram illustrating iterative function boundary splitting responsive to out-of-boundary jump analysis, in which cross-boundary jumps from different function boundaries to a common target address cause successive boundary refinement, in various aspects; and

FIG. 4 shows an example diagram illustrating disambiguation of cold-hot split code from separate function entries, in which a candidate out-of-boundary target is determined to be a relocated block of an existing function rather than a new function entry point, in various aspects.

### DESCRIPTION

The following detailed description refers to the accompanying drawings that show, by way of illustration, specific details and aspects in which the proposed configuration may be practiced. These aspects are described in sufficient detail to enable those skilled in the art to practice the proposed configuration. Other aspects may be utilized and structural, logical, and electrical changes may be made without departing from the scope of the proposed configuration. The various aspects are not necessarily mutually exclusive, as some aspects may be combined with one or more other aspects to form new aspects. Various aspects are described in connection with methods and various aspects are described in connection with devices (e.g., a memory module, a computing system). However, it is understood that aspects described in connection with methods may apply in a corresponding manner to the devices, and vice versa.

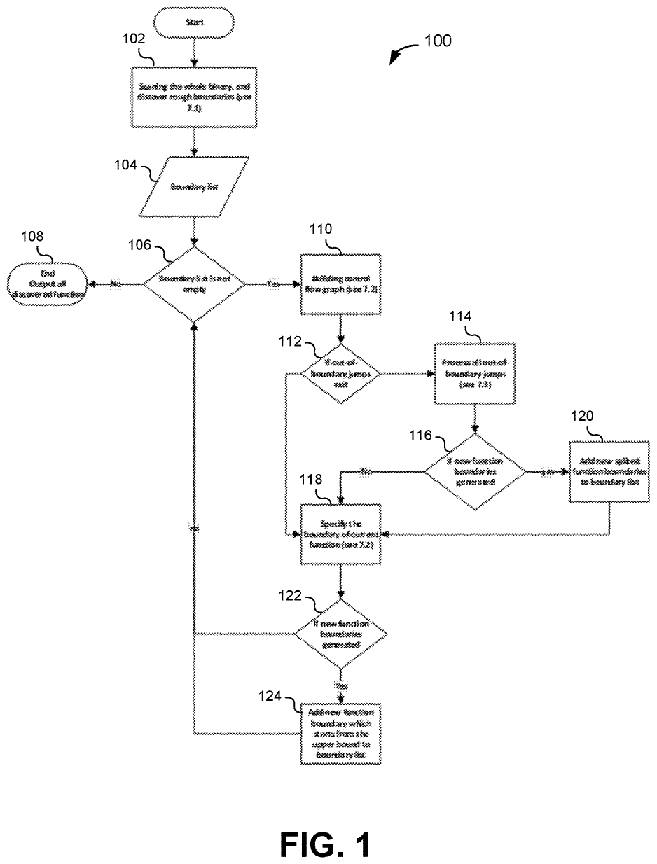

Referring to FIG. 1, a method 100 for discovering function boundaries in a stripped binary executable is described. In various aspects, a stripped binary executable lacks function symbol information and may contain one or more executable sections. Approaches consistent with the present teachings may use execution profiling data to guide a discovery process. Such execution profiling data may be indicative of executed addresses and branch targets observed during execution of the stripped binary executable. The profiling data may be collected by hardware branch recording facilities, such as a last branch record (LBR) buffer or processor event-based sampling (PEBS), or by software-based instrumentation or sampling. The profiling data records, for each observed branch event, at least a source address and a target address, thereby identifying addresses at which actual instructions reside in the binary.

As shown in FIG. 1, the method 100 may begin with scanning the stripped binary executable and discovering rough function boundaries (block 102), as described in further detail below. The rough function boundaries discovered in 102 may be recorded in a boundary list 104. At test 106, it may be determined whether the boundary list 104 is empty. If the boundary list 104 is empty, the method 100 may end and the discovered functions may be output (108). If the boundary list 104 is not empty, a function boundary may be taken from the boundary list 104 and a control flow graph may be built for the function boundary (block 110). At test 112, it may be determined whether one or more out-of-boundary jumps exist in the control flow graph, i.e., whether one or more jump instructions within the function boundary have target addresses outside the function boundary.

If one or more out-of-boundary jumps exist, the out-of-boundary jumps may be processed (block 114), as described in further detail below. At test 116, it may be determined whether the processing in block 114 generated one or more new function boundaries. If so, the new split function boundaries may be added to the boundary list 104 (block 120). The boundary of the current function may then be specified (block 118), e.g., an upper bound of the current function may be determined based on a last instruction reachable within the control flow graph, as described in further detail below. The boundary of the current function may likewise be specified in block 118 if no out-of-boundary jumps exist in as determined at test 112 or if no new function boundaries are generated in as determined at test 116. At test 122, it may be determined whether specifying the boundary of the current function in block 118 revealed a new function boundary, e.g., a previously undiscovered function beginning after the upper bound of the current function. If so, the new function boundary, which starts from the upper bound of the current function, may be added to the boundary list 104 (block 124). The method 100 may then return to test 106, and the method 100 may continue until the boundary list 104 is empty.

In a first phase of the method 100, the system populates a credible address data structure with addresses derived from the execution profiling data. The credible address data structure is initialized by identifying one or more executable sections in the stripped binary executable, for example by parsing segment information in an executable and linkable format (ELF) file header and recording the beginning address of each executable section. Each executed address recorded in the profiling data is also added to the credible address data structure. Because the profiling data reflects actual execution, the addresses recorded therein correspond to verified instruction locations within the executable sections. The credible address data structure thereby serves as a set of verified instruction addresses that anchor subsequent decoding, preventing the decoder from becoming desynchronized in regions where data is interleaved with code within an executable section.

The system discovers a plurality of rough function boundaries by decoding instructions beginning at each address in the credible address data structure. When instruction decoding fails at a current address, the system may terminate the decoding operation at that address, since a processor is unable to directly execute an invalid instruction sequence. Alternatively, responsive to a decoding failure at a current address, the system may increment the current address by one byte and resume the decoding at the incremented address. If the decoded instruction is a direct call instruction, the target address of the call is identified as a function entry point. If the decoded instruction is an indirect call instruction and the execution profiling data includes recorded targets for that instruction, each recorded target is identified as a function entry point. If the decoded instruction is a branch instruction, each target of the branch instruction is added to the credible address data structure so that subsequent decoding iterations will visit those addresses. The system repeats this decoding process until all addresses in the credible address data structure have been visited.

Each identified function entry point defines the lower bound of a rough function boundary. The rough function boundary for a given function entry point encompasses the address range from that entry point to the entry point of the next sequential function. The start and end addresses of the rough function boundary may be further refined using exception handling (EH) data, if such data is available in the stripped binary executable.

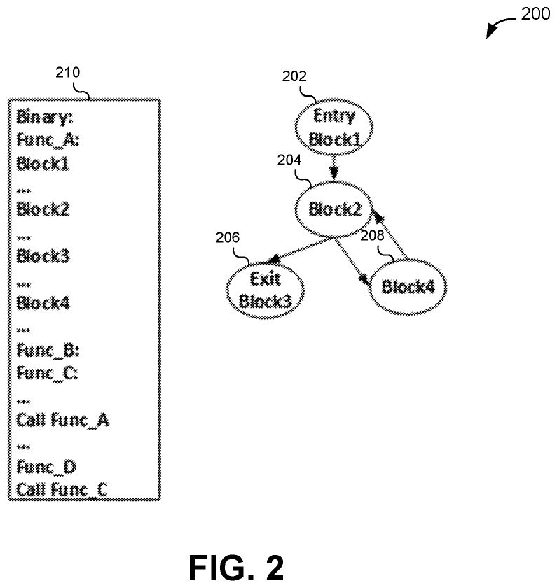

Referring to FIG. 2, in a second phase of the method 100, the system refines the rough function boundaries by constructing a control flow graph (CFG) for a respective function. As illustrated in diagram 200, a binary 210 includes a function A having blocks Block1 through Block4. The system constructs the CFG starting from the function entry point, namely entry block 202 (Block1), and traversing direct and conditional branch targets to identify all reachable basic blocks, in this example block 204 (Block2), exit block 206 (Block3), and block 208 (Block4). The last instruction, in address order, of the last reachable block within the CFG defines the upper bound of the function boundary. In the example of FIG. 2, the upper bound of function A is the last instruction of Block4 (block 208), which is the last reachable block in address order within the binary 210, even though Block3 (exit block 206) is the exit block of the CFG.

After determining the upper bound of a function, the system examines the instruction immediately following the upper bound. If the following instructions consist of one or more no-operation (NOP) instructions or interrupt instructions (such as INT3 in an x86 architecture), the system skips past them. The first non-NOP, non-interrupt instruction following the upper bound is identified as the entry point of a previously undiscovered function. In the example of FIG. 2, function B resides between function A and function C but was not discovered during the first phase because no call instruction in the binary targets function B. By constructing the CFG for function A and determining its upper bound, the system discovers function B as the function beginning at the next instruction after the upper bound of function A. This process continues until the system reaches the entry point of a function that was previously discovered.

During CFG construction, the system encounters indirect jump instructions whose targets may not be fully known from static analysis. The system uses the execution profiling data to classify indirect jumps. If the profiling data indicates that at least one target of an indirect jump is within the boundary of the current function, the system treats the indirect jump as an intra-function branch and continues CFG construction past the indirect jump. If the profiling data indicates that at least one target of an indirect jump is outside the boundary of the current function, the system classifies the indirect jump as a tail call. If no profiling data is available for a particular indirect jump, the system treats the instruction as a non-branching instruction and continues to the next sequential instruction.

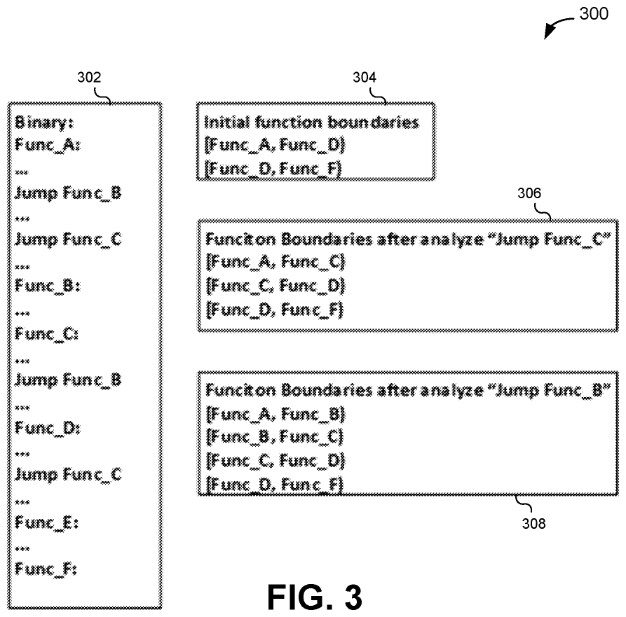

Referring to FIG. 3, in a third phase of the method 100, the system performs out-of-boundary jump analysis to discover additional function boundaries. This phase relies on two properties that hold for binaries produced by modern compiler toolchains, including GCC, LLVM/Clang, MSVC, and ICC/ICX. The first property is that each function has exactly one entry point. The second property is that no two functions share the same binary code. These properties are referred to herein as the single-entry property and the no-code-sharing property, respectively.

As illustrated in diagram 300, when a jump instruction within a first function boundary has a target address that lies outside the first function boundary, and a jump instruction within a second function boundary, different from the first function boundary, also has a target at the same target address, the system determines that the target address is a new function entry point. This determination follows from the no-code-sharing property: because the target address is reached from two different functions, the target address cannot be an internal block of either function and must instead be the entry point of a third function.

Responsive to determining that the target address is a new function entry point, the system splits the function boundary that contains the target address into two refined function boundaries. The first refined function boundary begins at the original entry point and ends at the target address. The second refined function boundary begins at the target address and ends at the original upper bound. In the example of FIG. 3, a binary 302 includes functions Func_A through Func_F, and the initial boundaries, shown at 304, are [Func_A, Func_D) and [Func_D, Func_F). Because both boundaries contain jump instructions targeting Func_C, the system determines that Func_C is a new function entry point and splits [Func_A, Func_D) into [Func_A, Func_C) and [Func_C, Func_D), as shown at 306. After this split, the system re-examines the refined boundaries and determines that [Func_A, Func_C) and [Func_C, Func_D) both contain jump instructions targeting Func_B, causing a further split of [Func_A, Func_C) into [Func_A, Func_B) and [Func_B, Func_C), as shown at 308. The system iterates this process, rebuilding the control flow graphs for each newly split boundary and examining them for additional out-of-boundary jumps, until no further boundary splits are generated.

For indirect jumps analyzed during this phase, the system uses the execution profiling data to resolve targets. If the profiling data indicates that one target of an indirect jump is a known function entry point, the system determines that all other recorded targets of that indirect jump are also function entry points of respective different functions. This determination follows from the single-entry property and the no-code-sharing property: if the indirect jump dispatches to multiple functions, each target must be a distinct function entry.

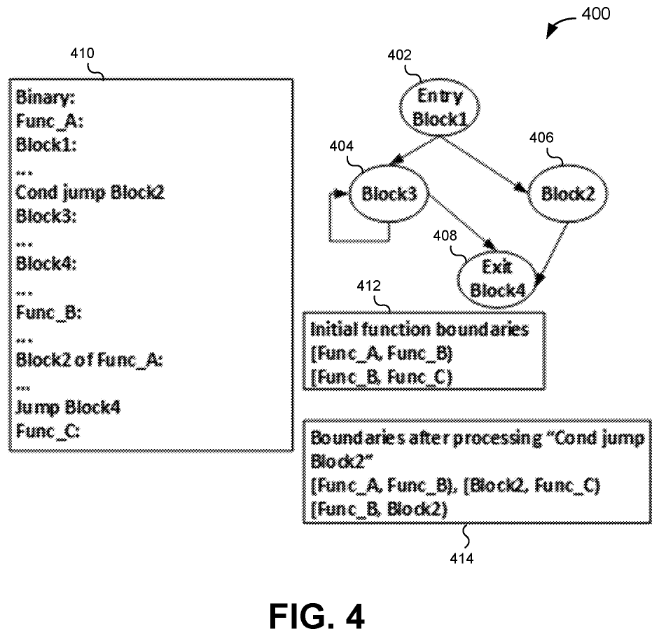

Referring to FIG. 4, when a jump instruction within a function boundary has a target address outside the function boundary, and the target address is reachable only by jumps originating within the same function boundary (i.e., no jumps from any other function boundary target the same address), the system cannot apply the cross-boundary rule described above. This situation commonly arises from cold-hot code splitting, in which a compiler separates infrequently executed blocks of a function into a different region of the executable section. In such cases, the out-of-boundary target may be either a new function entry point or a relocated block belonging to the current function.

To disambiguate these cases, the system may perform a multi-stage candidate evaluation procedure. In a first stage, the system tentatively designates the target address as a candidate function entry point and constructs a candidate control flow graph beginning at the target address. In a second stage, the system rebuilds the control flow graph for the original function boundary, treating each jump from the original function boundary to the target address as a tail call. During this rebuilding, jumps from the original function boundary to targets other than the candidate function entry point are not reclassified as tail calls.

In a third stage, the system examines the candidate control flow graph and the rebuilt control flow graph for bidirectional jump relationships. The system determines that the target address is not a new function entry point responsive to detecting either of two conditions: (a) the candidate control flow graph contains a jump instruction whose target is within the original function boundary, indicating that the candidate code region transfers control back into the original function; or (b) the rebuilt control flow graph for the original function boundary contains a jump instruction whose target is within the candidate control flow graph at an address other than the candidate function entry point, indicating that the original function accesses an interior point of the candidate region rather than its entry. If either condition is satisfied, the system concludes that the candidate region is a relocated block belonging to the original function rather than a separate function, and the system associates both the original function boundary and the address range of the candidate control-flow graph with the same function. A function may accordingly have more than one associated address range when cold-hot splitting has relocated one or more of its blocks.

If neither condition is satisfied, the system determines that the target address is a new function entry point. As an optional confirmation operation, the system may examine whether the candidate control flow graph contains a recognizable function prologue sequence, a recognizable function epilogue sequence, or both. A function prologue sequence may comprise, for example, a push instruction saving a frame pointer register followed by a move instruction establishing a new frame pointer. A function epilogue sequence may comprise, for example, a pop instruction restoring the frame pointer register followed by a return instruction. The presence of such sequences within the candidate control flow graph provides additional evidence that the target address is a genuine function entry point. This confirmation operation is instruction set architecture (ISA) specific and may be adapted for different architectures.

In the example of FIG. 4, a binary 410 includes a function A having an entry block 402 (Block1), a block 404 (Block3), a block 406 (Block2), and an exit block 408 (Block4), and the initial function boundaries, shown at 412, are [Func_A, Func_B) and [Func_B, Func_C). A conditional jump instruction in Block1 of function A targets Block2, which resides outside the [Func_A, Func_B) boundary in the region [Block2, Func_C). Only jumps within [Func_A, Func_B) target Block2, so the cross-boundary rule does not directly apply. The system tentatively treats Block2 as a candidate function entry point and constructs its candidate control flow graph. The candidate control flow graph reveals a jump from Block2 to Block4, which resides within [Func_A, Func_B). Because the candidate control flow graph contains a jump back into the original function boundary, condition (a) is satisfied, and the system determines that Block2 is not a new function entry point. Instead, Block2 is a cold block that was relocated by a cold-hot splitting compiler optimization, and the binary contained in both [Func_A, Func_B) and [Block2, Func_C) belongs to the same function A. The resulting boundaries after processing the conditional jump, shown at 414, are [Func_A, Func_B), [Func_B, Block2), and [Block2, Func_C), with [Func_A, Func_B) and [Block2, Func_C) associated with the same function A.

In a fourth phase of the method 100, the system performs correctness verification of the discovered function boundaries using exception handling metadata. The stripped binary executable may contain an exception handling table that records, for each function with exception handling information, a function start address and a function end address. The system compares the set of discovered function boundaries against the entries in the exception handling table to compute a match ratio. The match ratio represents the proportion of exception handling table entries for which a corresponding discovered function boundary exists.

If the match ratio meets or exceeds a predetermined threshold, the system uses the function end addresses recorded in the exception handling table to validate and correct the discovered boundaries. In particular, the system uses the exception handling end addresses to determine the sizes of indirect jump tables within functions, preventing the system from erroneously decoding jump table data as instructions. For candidate leaf functions that lack exception handling metadata, the system performs address space conflict detection by checking whether the address range of the candidate leaf function overlaps with the address range of any function recorded in the exception handling table. Any candidate leaf function whose address range conflicts with a known exception handling range is flagged as erroneous and discarded.

If the match ratio falls below the predetermined threshold, the system determines that the stripped binary executable is likely protected by an obfuscation mechanism or anti-analysis countermeasure, such as an anti-cheat system, that has disrupted the normal correspondence between exception handling metadata and function boundaries. In this case, the system terminates the function boundary discovery process to prevent propagation of analysis errors. The predetermined threshold may be a configurable value set by a user or determined empirically for a given class of binaries.

The function boundary discovery techniques described herein may provide one or more advantageous effects. Anchoring instruction decoding at addresses derived from the execution profiling data may prevent the decoder from desynchronizing in regions where data is interleaved with code, and may accordingly increase the completeness of the discovered function boundaries. Resolving targets of indirect call instructions and indirect jump instructions from the execution profiling data may allow discovery of functions that are reached exclusively through indirect control flow. The out-of-boundary jump analysis based on the single-entry property and the no-code-sharing property may allow discovery of functions that are not targeted by any call instruction in the stripped binary executable, and the candidate evaluation procedure may distinguish relocated cold blocks produced by cold-hot splitting from genuine function entry points, reducing erroneous function identifications. The correctness verification based on the match ratio may prevent propagation of analysis errors when the stripped binary executable is protected by an obfuscation mechanism.

The function boundary discovery operations described herein may be carried out by a binary analysis system. The binary analysis system may include one or more processors and one or more memories storing the stripped binary executable, the execution profiling data, the credible address data structure, the boundary list 104, and instructions that, when executed, carry out one or more of the operations described herein. The instructions may be stored on a non-transitory machine-readable storage medium, e.g., a magnetic storage medium, an optical storage medium, or a semiconductor memory. One or more of the operations may alternatively or additionally be implemented in dedicated circuitry, e.g., a binary analysis circuit for carrying out one or more of the function boundary discovery operations, a decoder circuit for decoding instructions of the stripped binary executable, a graph construction circuit for constructing control flow graphs, or a boundary refinement circuit for splitting function boundaries, or in any combination of circuitry and instructions executed by one or more processors. The binary analysis system may be implemented, for example, in a server, a workstation, a desktop computer, a laptop computer, or a distributed or cloud computing system, or may be integrated as a component of a binary translation system, a compiler toolchain, a performance analysis tool, or a security analysis tool. An enabling or controlling entity, e.g., an operating system, a driver, a hypervisor, or a controller, may enable, disable, or configure collection of the execution profiling data, and may enable, disable, or configure one or more of the function boundary discovery operations, e.g., may configure the predetermined threshold for the match ratio.

In some aspects, the execution profiling data may be collected using hardware profiling facilities associated with a microprocessor. For example, last branch record facilities of the processor may record source addresses and target addresses of recently executed branches in a set of registers of the processor, and processor event-based sampling facilities of the processor may capture branch records into a memory buffer. Alternatively or additionally, a control flow trace generated by the processor may be decoded to obtain the executed addresses and the branch targets of the execution profiling data.

A process for making a binary analysis system as described herein may include providing one or more processors; coupling one or more memories to the one or more processors; and storing, in the one or more memories, instructions that, when executed by the one or more processors, cause the one or more processors to carry out any of the function boundary discovery methods described herein, e.g., obtaining execution profiling data, populating a credible address data structure, discovering a plurality of rough function boundaries, constructing control flow graphs, and splitting function boundaries responsive to out-of-boundary jump analysis.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “at least one” and “one or more” may be understood to include any integer number greater than or equal to one, i.e., one, two, three, four, [. . . ], etc. The term “a plurality” or “a multiplicity” may be understood to include any integer number greater than or equal to two, i.e. two, three, four, five, [. . . ], etc. The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The terms “processor” as used herein may be understood as any kind of technological entity that allows handling of data. The data may be handled according to one or more specific functions that the processor execute. Further, a processor as used herein may be understood as any kind of circuit, e.g., any kind of analog or digital circuit. A processor may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions may also be understood as a processor. It is understood that any two (or more) of the processors detailed herein may be realized as a single entity with equivalent functionality or the like, and conversely that any single processor detailed herein may be realized as two (or more) separate entities with equivalent functionality or the like.

In the following, various examples are provided that may include one or more aspects described above.

Example 1 is a method comprising: obtaining execution profiling data indicative of executed addresses and branch targets observed during execution of a stripped binary executable, the stripped binary executable lacking function symbol information; populating a credible address data structure with addresses derived from the execution profiling data; discovering a plurality of rough function boundaries in the stripped binary executable by decoding instructions beginning at addresses in the credible address data structure and identifying function entry points from call targets encountered during the decoding, wherein a respective rough function boundary of the plurality of rough function boundaries defines an address range between a respective function entry point and a next sequential function entry point; constructing a control flow graph for the respective rough function boundary and determining an upper bound of the respective rough function boundary based on a last instruction reachable within the control flow graph; responsive to identifying a jump instruction within a first function boundary having a target address outside the first function boundary, determining whether the target address is a new function entry point based at least in part on whether a jump instruction within a second function boundary, different from the first function boundary, also targets the target address; and responsive to determining that the target address is the new function entry point, splitting the first function boundary into a first refined function boundary ending at the target address and a second refined function boundary beginning at the target address.

Example 2 is the method of Example 1, wherein the execution profiling data comprises branch records collected by a hardware branch recording facility, by processor event-based sampling, or by software-based instrumentation or sampling.

Example 3 is the method of Example 1 or 2, wherein the populating comprises identifying one or more executable sections of the stripped binary executable by parsing segment information of an executable and linkable format header and recording a beginning address of a respective executable section of the one or more executable sections in the credible address data structure.

Example 4 is the method of any one of Examples 1 to 3, further comprising, during the decoding, responsive to a decoding failure at a current address, incrementing the current address by one byte and resuming the decoding.

Example 5 is the method of any one of Examples 1 to 4, further comprising, during the decoding, responsive to encountering a branch instruction, adding one or more targets of the branch instruction to the credible address data structure.

Example 6 is the method of any one of Examples 1 to 5, further comprising, during the decoding, responsive to encountering an indirect call instruction, resolving one or more targets of the indirect call instruction from the execution profiling data and identifying the one or more resolved targets as respective function entry points.

Example 7 is the method of any one of Examples 1 to 6, further comprising refining a start address or an end address of the respective rough function boundary using exception handling data of the stripped binary executable.

Example 8 is the method of any one of Examples 1 to 7, further comprising, after determining the upper bound of the respective rough function boundary, skipping one or more no-operation instructions or interrupt instructions following the upper bound and identifying a first subsequent instruction that is not a no-operation instruction or an interrupt instruction as a function entry point of a further function.

Example 9 is the method of any one of Examples 1 to 8, further comprising classifying an indirect jump instruction encountered during the constructing of the control flow graph by: responsive to the execution profiling data indicating a target of the indirect jump instruction within the respective rough function boundary, continuing the constructing of the control flow graph past the indirect jump instruction; responsive to the execution profiling data indicating a target of the indirect jump instruction outside the respective rough function boundary, classifying the indirect jump instruction as a tail call; and responsive to the execution profiling data including no recorded target for the indirect jump instruction, treating the indirect jump instruction as a non-branching instruction.

Example 10 is the method of any one of Examples 1 to 9, further comprising, responsive to the execution profiling data indicating that a first target of an indirect jump instruction is a function entry point, determining that one or more further targets of the indirect jump instruction recorded in the execution profiling data are function entry points of respective different functions.

Example 11 is the method of any one of Examples 1 to 10, further comprising rebuilding control flow graphs for the first refined function boundary and the second refined function boundary and repeating the determining and the splitting until no further new function entry point is identified.

Example 12 is the method of any one of Examples 1 to 11, further comprising, responsive to identifying a jump instruction within a third function boundary having a target address outside the third function boundary, the target address of the jump instruction within the third function boundary being reachable only by jumps within the third function boundary: tentatively designating the target address of the jump instruction within the third function boundary as a candidate function entry point and constructing a candidate control flow graph beginning at the candidate function entry point; rebuilding a control flow graph for the third function boundary, treating one or more jumps from the third function boundary to the candidate function entry point as tail calls; determining that the candidate function entry point is not a function entry point responsive to detecting a jump from the candidate control flow graph to the third function boundary or a jump from the third function boundary into the candidate control flow graph at an address other than the candidate function entry point; and determining that the candidate function entry point is a function entry point of a function different from a function associated with the third function boundary responsive to an absence of both the jump from the candidate control flow graph to the third function boundary and the jump from the third function boundary into the candidate control flow graph at the address other than the candidate function entry point.

Example 13 is the method of Example 12, further comprising, responsive to determining that the candidate function entry point is not a function entry point, associating the third function boundary and an address range of the candidate control flow graph with a same function, the same function being associated with more than one address range.

Example 14 is the method of Example 12 or 13, further comprising confirming that the candidate function entry point is a function entry point based on detection of at least one of a function prologue sequence or a function epilogue sequence within the candidate control flow graph.

Example 15 is the method of any one of Examples 1 to 14, further comprising: comparing a set of discovered function boundaries against entries in an exception handling table associated with the stripped binary executable to compute a match ratio; responsive to the match ratio falling below a threshold, determining that the stripped binary executable is protected by an obfuscation mechanism and terminating discovery of function boundaries; and responsive to the match ratio meeting or exceeding the threshold, utilizing function end addresses recorded in the exception handling table to correct a size of one or more indirect jump tables within the discovered function boundaries.

Example 16 is the method of Example 15, further comprising performing address space conflict detection for a candidate leaf function lacking exception handling metadata by checking whether an address range of the candidate leaf function overlaps with an address range of a function recorded in the exception handling table, and discarding the candidate leaf function responsive to detecting an overlap.

Example 17 is a system comprising: a processor; and a memory coupled to the processor, the memory storing instructions configured to cause the processor, when the instructions are executed by the processor, to perform the method of any one of Examples 1 to 16.

Example 18 is an apparatus comprising: a memory configured to store execution profiling data indicative of executed addresses and branch targets observed during execution of a stripped binary executable; and a processor configured to perform the method of any one of Examples 1 to 16 using the execution profiling data stored in the memory.

Example 19 is an apparatus comprising a binary analysis circuit for carrying out the method of any one of Examples 1 to 16.

Example 20 is a non-transitory machine-readable storage medium storing instructions that, when executed by a processor, cause the processor to perform the method of any one of Examples 1 to 16.

Example 21 is a computer program comprising instructions which, when the program is executed by a computer, cause the computer to carry out the method of any one of Examples 1 to 16.

Example 22 is a process of making a binary analysis system, the process comprising: providing one or more processors; coupling one or more memories to the one or more processors; and storing, in the one or more memories, instructions that, when executed by the one or more processors, cause the one or more processors to perform the method of any one of Examples 1 to 16.

What is claimed is:

1. A system comprising:
a processor; and
a memory coupled to the processor, the memory storing instructions that, when executed by the processor, cause the processor to:
obtain execution profiling data indicative of executed addresses and branch targets observed during execution of a stripped binary executable, the stripped binary executable lacking function symbol information;
populate a credible address data structure with addresses derived from the execution profiling data;
discover a plurality of rough function boundaries in the stripped binary executable by decoding instructions beginning at addresses in the credible address data structure and identifying function entry points from call targets encountered during the decoding, wherein a respective rough function boundary of the plurality of rough function boundaries defines an address range between a respective function entry point and a next sequential function entry point;
construct a control flow graph for the respective rough function boundary and determine an upper bound of the respective rough function boundary based on a last instruction reachable within the control flow graph;
responsive to identifying a jump instruction within a first function boundary having a target address outside the first function boundary, determine whether the target address is a new function entry point based at least in part on whether a jump instruction within a second function boundary, different from the first function boundary, also targets the target address; and
responsive to determining that the target address is the new function entry point, split the first function boundary into a first refined function boundary ending at the target address and a second refined function boundary beginning at the target address.

2. The system of claim 1, wherein the execution profiling data comprises branch records collected by a hardware branch recording facility.

3. The system of claim 1, wherein the instructions further cause the processor to, during the decoding, responsive to encountering an indirect call instruction, resolve one or more targets of the indirect call instruction from the execution profiling data and identify the one or more resolved targets as respective function entry points.

4. The system of claim 1, wherein the instructions further cause the processor to, during the decoding, responsive to a decoding failure at a current address, increment the current address by one byte and resume the decoding, and responsive to encountering a branch instruction, add one or more targets of the branch instruction to the credible address data structure.

5. The system of claim 1, wherein the instructions further cause the processor to, after determining the upper bound of the respective rough function boundary, skip one or more no-operation instructions or interrupt instructions following the upper bound and identify a first subsequent instruction that is not a no-operation instruction or an interrupt instruction as a function entry point of a further function.

6. The system of claim 1, wherein the instructions further cause the processor to, responsive to identifying a jump instruction within a third function boundary having a target address outside the third function boundary, the target address of the jump instruction within the third function boundary being reachable only by jumps within the third function boundary:
tentatively designate the target address of the jump instruction within the third function boundary as a candidate function entry point and construct a candidate control flow graph beginning at the candidate function entry point;
rebuild a control flow graph for the third function boundary, treating one or more jumps from the third function boundary to the candidate function entry point as tail calls;
determine that the candidate function entry point is not a function entry point responsive to detecting a jump from the candidate control flow graph to the third function boundary or a jump from the third function boundary into the candidate control flow graph at an address other than the candidate function entry point; and
determine that the candidate function entry point is a function entry point of a function different from a function associated with the third function boundary responsive to an absence of both the jump from the candidate control flow graph to the third function boundary and the jump from the third function boundary into the candidate control flow graph at the address other than the candidate function entry point.

7. The system of claim 6, wherein the instructions further cause the processor to confirm that the candidate function entry point is the function entry point of the different function based on detection of at least one of a function prologue sequence or a function epilogue sequence within the candidate control flow graph.

8. The system of claim 1, wherein the instructions further cause the processor to:
compare a set of discovered function boundaries against entries in an exception handling table associated with the stripped binary executable to compute a match ratio;
responsive to the match ratio falling below a threshold, determine that the stripped binary executable is protected by an obfuscation mechanism and terminate discovery of function boundaries; and
responsive to the match ratio meeting or exceeding the threshold, utilize function end addresses recorded in the exception handling table to correct a size of one or more indirect jump tables within the discovered function boundaries.

9. A method comprising:
obtaining execution profiling data indicative of executed addresses and branch targets observed during execution of a stripped binary executable, the stripped binary executable lacking function symbol information;
populating a credible address data structure with addresses derived from the execution profiling data;
discovering a plurality of rough function boundaries in the stripped binary executable by decoding instructions beginning at addresses in the credible address data structure and identifying function entry points from call targets encountered during the decoding, wherein a respective rough function boundary of the plurality of rough function boundaries defines an address range between a respective function entry point and a next sequential function entry point;
constructing a control flow graph for the respective rough function boundary and determining an upper bound of the respective rough function boundary based on a last instruction reachable within the control flow graph;
responsive to identifying a jump instruction within a first function boundary having a target address outside the first function boundary, determining whether the target address is a new function entry point based at least in part on whether a jump instruction within a second function boundary, different from the first function boundary, also targets the target address; and
responsive to determining that the target address is the new function entry point, splitting the first function boundary into a first refined function boundary ending at the target address and a second refined function boundary beginning at the target address.

10. The method of claim 9, further comprising, during the decoding, responsive to encountering an indirect call instruction, resolving one or more targets of the indirect call instruction from the execution profiling data and identifying the one or more resolved targets as respective function entry points.

11. The method of claim 9, further comprising, after determining the upper bound of the respective rough function boundary, skipping one or more no-operation instructions or interrupt instructions following the upper bound and identifying a first subsequent instruction that is not a no-operation instruction or an interrupt instruction as a function entry point of a further function.

12. The method of claim 9, further comprising classifying an indirect jump instruction encountered during the constructing of the control flow graph by:
responsive to the execution profiling data indicating a target of the indirect jump instruction within the respective rough function boundary, continuing the constructing of the control flow graph past the indirect jump instruction;
responsive to the execution profiling data indicating a target of the indirect jump instruction outside the respective rough function boundary, classifying the indirect jump instruction as a tail call; and
responsive to the execution profiling data including no recorded target for the indirect jump instruction, treating the indirect jump instruction as a non-branching instruction.

13. The method of claim 9, further comprising, responsive to the execution profiling data indicating that a first target of an indirect jump instruction is a function entry point, determining that one or more further targets of the indirect jump instruction recorded in the execution profiling data are function entry points of respective different functions.

14. The method of claim 9, further comprising:
comparing a set of discovered function boundaries against entries in an exception handling table associated with the stripped binary executable to compute a match ratio;
responsive to the match ratio falling below a threshold, determining that the stripped binary executable is protected by an obfuscation mechanism and terminating discovery of function boundaries; and
responsive to the match ratio meeting or exceeding the threshold, utilizing function end addresses recorded in the exception handling table to correct a size of one or more indirect jump tables within the discovered function boundaries.

15. A non-transitory machine-readable storage medium storing instructions that, when executed by a processor, cause the processor to:
obtain execution profiling data indicative of executed addresses and branch targets observed during execution of a stripped binary executable, the stripped binary executable lacking function symbol information;
populate a credible address data structure with addresses derived from the execution profiling data;
discover a plurality of rough function boundaries in the stripped binary executable by decoding instructions beginning at addresses in the credible address data structure and identifying function entry points from call targets encountered during the decoding, wherein a respective rough function boundary of the plurality of rough function boundaries defines an address range between a respective function entry point and a next sequential function entry point;
construct a control flow graph for the respective rough function boundary and determine an upper bound of the respective rough function boundary based on a last instruction reachable within the control flow graph;
responsive to identifying a jump instruction within a first function boundary having a target address outside the first function boundary, determine whether the target address is a new function entry point based at least in part on whether a jump instruction within a second function boundary, different from the first function boundary, also targets the target address; and
responsive to determining that the target address is the new function entry point, split the first function boundary into a first refined function boundary ending at the target address and a second refined function boundary beginning at the target address.

16. The non-transitory machine-readable storage medium of claim 15, wherein the execution profiling data comprises branch records collected by a hardware branch recording facility.

17. The non-transitory machine-readable storage medium of claim 15, wherein the instructions further cause the processor to, during the decoding, responsive to encountering an indirect call instruction, resolve one or more targets of the indirect call instruction from the execution profiling data and identify the one or more resolved targets as respective function entry points.

18. The non-transitory machine-readable storage medium of claim 15, wherein the instructions further cause the processor to rebuild control flow graphs for the first refined function boundary and the second refined function boundary and to repeat the determination of new function entry points and the splitting of function boundaries until no further new function entry point is identified.

19. The non-transitory machine-readable storage medium of claim 15, wherein the instructions cause the processor to populate the credible address data structure at least in part by identifying one or more executable sections of the stripped binary executable by parsing segment information of an executable and linkable format header and recording a beginning address of a respective executable section of the one or more executable sections in the credible address data structure.

20. The non-transitory machine-readable storage medium of claim 15, wherein the instructions further cause the processor to:
compare a set of discovered function boundaries against entries in an exception handling table associated with the stripped binary executable to compute a match ratio;
responsive to the match ratio falling below a threshold, determine that the stripped binary executable is protected by an obfuscation mechanism and terminate discovery of function boundaries; and
responsive to the match ratio meeting or exceeding the threshold, utilize function end addresses recorded in the exception handling table to correct a size of one or more indirect jump tables within the discovered function boundaries.
